(19) United States
(12) Patent Application Publication
(10) Pub. No.: US 2012/0182001 A1
(43) Pub. Date: Jul. 19, 2012

(54) LOW INPUT VOLTAGE BOOST CONVERTER OPERABLE AT LOW TEMPERATURES AND BOOST CONTROLLER THEREOF

(75) Inventors: Chao-Chung HUANG, Taipei (TW); Yen-Hui WANG, Taipei (TW)

(73) Assignee: IMMENSE ADVANCE TECHNOLOGY CORP., Taipei (TW)

(21) Appl. No.: 13/007,888

(22) Filed: Jan. 17, 2011

(51) Int. Cl. G05F 1/10

(52) U.S. Cl. 323/283; 323/282

(57) ABSTRACT

A low input voltage boost converter operable at low temperatures, comprising a boost controller and an NMOS transistor. The boost controller has a driver unit, a first inverter circuit, a second inverter circuit, and a comparator circuit, wherein the first inverter circuit is used to enhance the high level of a switching signal during a startup period.

### BACKGROUND OF THE INVENTION

1. Field of the Invention

The present invention relates to a boost-type power converter and a controller thereof, and more particularly to a low input voltage boost-type power converter operable at low temperatures and a boost controller thereof.

2. Description of the Related Art

Please refer to FIG. 1a, which illustrates the circuit diagram of a prior art boost converter circuit. As can be seen in FIG. 1a, the boost converter circuit includes a boost converter 100, an inductor 130, a Shottky diode 140, a capacitor 150, and a resistor 160.

The boost converter 100, including a boost controller 110 and an NMOS transistor 120, is a three-pin integrated chip, of which the package is compatible with that of a MOSFET—popular and available, for minimizing the package size and packaging cost. The boost controller 110 therefore has to be powered by a DC supply voltage derived from V_{X}—the voltage at the anode of the Shottky diode 140, or from an output voltage V_{O}—the voltage across the resistor 160, wherein, if the DC supply voltage is powered by V_{X}, which has a repeated voltage notch caused by the switching of the NMOS transistor 120, a rectification circuit including a diode is needed in the boost controller 110 to build up the DC supply voltage. When in operation, the boost controller 110 will send a switching signal V_{SW}, of which the amplitude is determined by the DC supply voltage, to switch the NMOS transistor 120 to repeatedly transfer an energy from an input voltage Y_{IN} at a lower level to the output voltage V_{O} at a higher level, by repeatedly storing the energy into the inductor 130 and then releasing it through the Shottky diode 140 to the capacitor 150 and the resistor 160. The process of storing the energy into the inductor 130 is illustrated in FIG. 1b, wherein I_{L,ON} represents a ramping up current through the inductor 130. The process of releasing the energy from the inductor 130 to the capacitor 150 and the resistor 160 is illustrated in FIG. 1c, wherein I_{L,OFF} represents a ramping down current flowing through the inductor 130, the Shottky diode 140—with a forward voltage drop of around 0.2V—and then the parallel combination of the capacitor 150 and the resistor 160. As the continuity of current flowing through the inductor 130 must be maintained, the polarity of voltage V_{L} across the inductor 130 is then forced to change from (+,−) to (−,+) after the NMOS transistor 120 is switched off. A boosted voltage is then generated at the anode of the Shottky diode 140 to turn on the Shottky diode 140 and thereby deliver the energy from the input voltage Y_{IN} at a lower level to the output voltage V_{O} at a higher level.

However, when the input voltage Y_{IN} is a low voltage source, for example a 0.9V voltage source, and the environmental temperature is at low temperatures, for example below −20° C., the prior art boost converter circuit may fail to function. The reasons are elaborated as follows:

1. The threshold voltage of the NMOS transistor 120 has a negative temperature coefficient of around −2 mV/° C. Therefore, if the threshold voltage is 0.6V at 25° C., then it will become 0.69V when the environmental temperature is at −20° C.

2. If the input voltage Y_{IN} is at 0.9V, the environmental temperature is at −20° C., and the DC supply voltage of the boost controller 110 is derived by a half-wave rectification of V_{X} to be equal to (V_{X}—the forward voltage drop of a rectification diode), then the high level of the switching signal V_{SW} (around 0.9V-0.7V=0.2V) will be much lower than the threshold voltage of the NMOS transistor 120 (0.69V as mentioned above), causing failure of the switching of the NMOS transistor 120, and thereby failure of the boost converter circuit.

3. On the other hand, if the DC supply voltage of the boost controller 110 is derived from the output voltage V_{O} with the input voltage V_{IN} being at 0.9V and the environmental temperature at −20° C., then the output voltage V_{O} will be at about 0.685V—equal to (the input voltage V_{IN}—the voltage drop of the inductor 130—the voltage drop of the Shottky diode 140) during the startup period, and the high level of the switching signal V_{SW} will be lower than the threshold voltage of the NMOS transistor 120 (0.69V as mentioned above), causing failure of the switching of the NMOS transistor 120, and thereby failure of the boost converter circuit.

To tackle the issues mentioned above, adopting a process having a lower threshold voltage seems to be a solution. However, a lower threshold voltage means a larger leakage current, and a larger leakage current can deteriorate the performance of power saving of the boost converter, especially when the boost converter is in standby mode.

In view of these problems, the present invention proposes a boost converter utilizing a novel boost controller, to overcome the effects of low input voltage and low environmental temperatures.

### SUMMARY OF THE INVENTION

One objective of the present invention is to propose a low input voltage boost converter operable at low temperatures.

Another objective of the present invention is to propose a boost controller for a low input voltage boost converter circuit operable at low temperatures.

To achieve the foregoing objectives of the present invention, a low input voltage boost converter operable at low temperatures is proposed, the boost converter including a boost controller and an NMOS transistor, wherein the boost controller has a first input end coupled to the anode of a Shottky diode, a second input end coupled to an output voltage, a switching signal output end for providing a switching signal, and a common end for connecting to a ground; and the boost controller includes a driver unit, a first inverter circuit, a second inverter circuit, and a comparator circuit.

The driver unit, powered by the output voltage, is used to generate a first switching signal.

The first inverter circuit, powered by the voltage at the anode of the Shottky diode, has an input end coupled to the first switching signal, a control end coupled to a control signal, and an output end coupled to the switching signal output end, wherein the first inverter circuit is active when the control signal is inactive, and disabled when the control signal is active.

The second inverter circuit, powered by the output voltage, has an input end coupled to the first switching signal, and an output end coupled to the switching signal output end.

The comparator circuit is used to generate the control signal by comparing the output voltage with a reference voltage.

The NMOS transistor has a gate terminal coupled to the switching signal output end, a drain terminal coupled to the anode of the Shottky diode, and a source terminal coupled to the ground.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1a illustrates the circuit diagram of a prior art boost converter circuit.

FIG. 1b illustrates the process of storing the energy into the inductor.

FIG. 1c illustrates the process of releasing the energy from the inductor to the capacitor and the resistor.

FIG. 2 illustrates the block diagram of a boost converter circuit including a boost converter according to a preferred embodiment of the present invention.

FIG. 3 illustrates the block diagram of a boost controller according to a preferred embodiment of the present invention.

FIG. 4 illustrates the block diagram of a boost controller according to another preferred embodiment of the present invention.

FIG. 5 illustrates the waveform diagram of major signals of the boost converter circuit in FIG. 2 during a startup period.

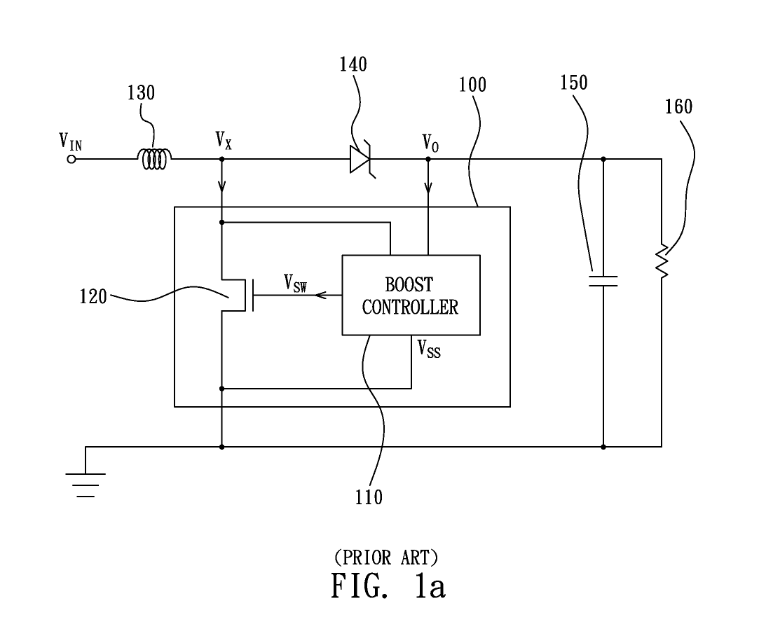

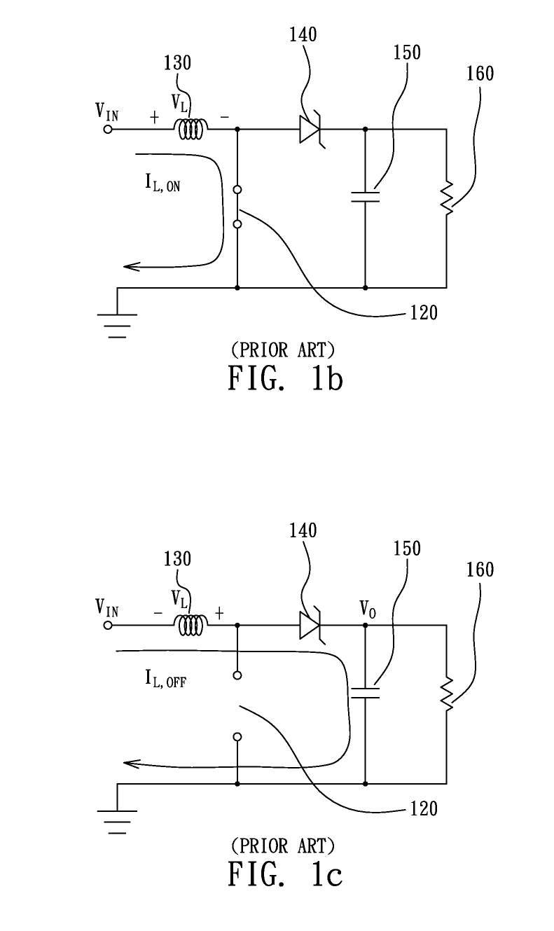

### DETAILED DESCRIPTION OF THE PREFERRED EMBODIMENTS

The present invention will be described in more detail hereinafter with reference to the accompanying drawings that show the preferred embodiment of the invention.

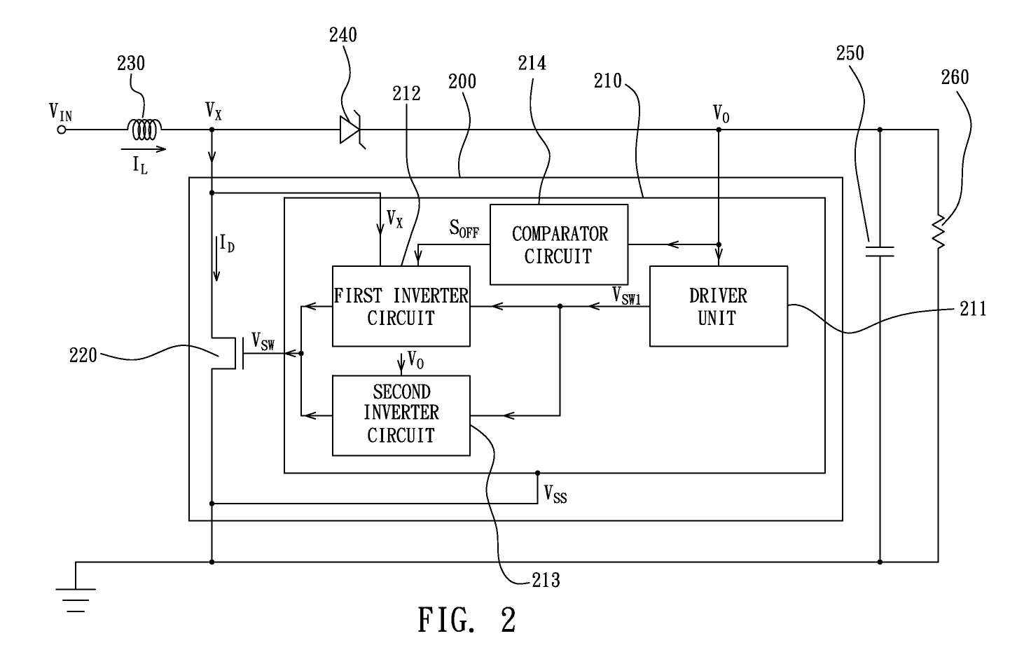

Please refer to FIG. 2, which illustrates the block diagram of a boost converter circuit including a boost converter according to a preferred embodiment of the present invention. As can be seen in FIG. 2, the boost converter circuit includes a boost converter 200, an inductor 230, a Shottky diode 240, a capacitor 250, and a resistor 260.

The boost converter 200 including a boost controller 210 and an NMOS transistor 220, wherein the boost controller 210 has a first input end coupled to the anode of the Shottky diode 240, a second input end coupled to an output voltage V_{O}, a switching signal output end for providing a switching signal V_{SW}, and a common end for connecting to a ground V_{SS}; and the boost controller 210 includes a driver unit 211, a first inverter circuit 212, a second inverter circuit 213, and a comparator circuit 214.

The driver unit 211, powered by the output voltage V_{O}, is used to generate a first switching signal V_{SW1}, of which the duty is determined by an error signal derived from the difference of the output voltage V_{O} and a first reference voltage.

The first inverter circuit 212, powered by V_{X}—the voltage at the anode of the Shottky diode 240, has an input end coupled to the first switching signal V_{SW1}, a control end coupled to a control signal S_{OFF}, and an output end coupled to the switching signal output end, wherein the first inverter circuit 212 is active if the control signal S_{OFF} is inactive, and disabled if the control signal S_{OFF} is active.

The second inverter circuit 213, powered by the output voltage V_{O}, has an input end coupled to the first switching signal V_{SW1}, and an output end coupled to the switching signal output end.

The comparator circuit 214 is used to generate the control signal S_{OFF} by comparing the output voltage V_{O} with a second reference voltage.

The NMOS transistor 220 has a gate terminal coupled to the switching signal output end, a drain terminal coupled to the anode of the Shottky diode 240, and a source terminal coupled to the ground.

During a startup period, the high level of the switching signal V_{SW} will be enhanced by the first inverter circuit 212 due to the fact that V_{X} is higher than the output voltage V_{O}. With the NMOS transistor 220 being effectively turned on, the output voltage V_{O} will build up cycle by cycle. When V_{O} reaches the second reference voltage, the control signal S_{OFF} will be active to disable the first inverter circuit 212, and the switching signal V_{SW} will then be solely provided by the second inverter circuit 213.

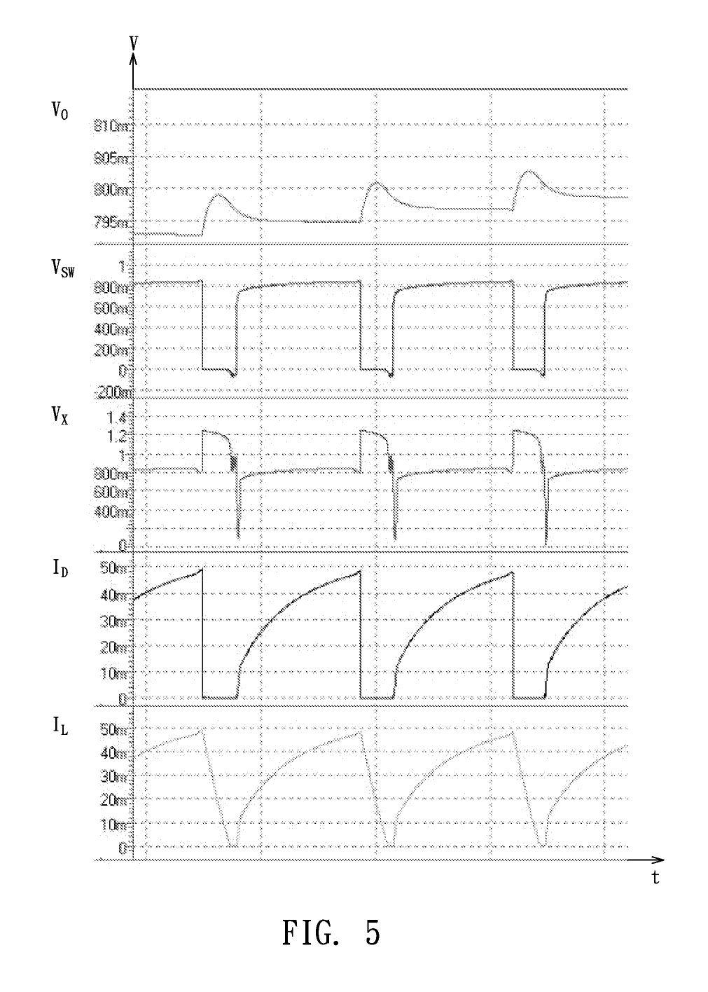

In a scenario of having an input voltage V_{IN} at 0.9V, and the environmental temperature at −20° C., the high level of the switching signal V_{SW} enhanced by the first inverter circuit 212 during a startup period will still be high enough for turning on the NMOS transistor 220—the threshold voltage of the NMOS transistor 220 is 0.69V, while V_{X} is around 0.9V. The waveform diagram of major signals V_{O}, V_{SW}, V_{X}, I_{D}, and I_{L} of the boost converter circuit in FIG. 2 during a startup period is illustrated in FIG. 5. As seen in FIG. 5, the high level of the switching signal V_{SW} is above 0.8V—pulled up by V_{X}, V_{O} is increasing cycle by cycle by receiving the energy stored in the ramping up periods of I_{L}, and the drain current I_{D} of the NMOS transistor 220 is approximately equal to I_{L} during the ramping up periods of I_{L}.

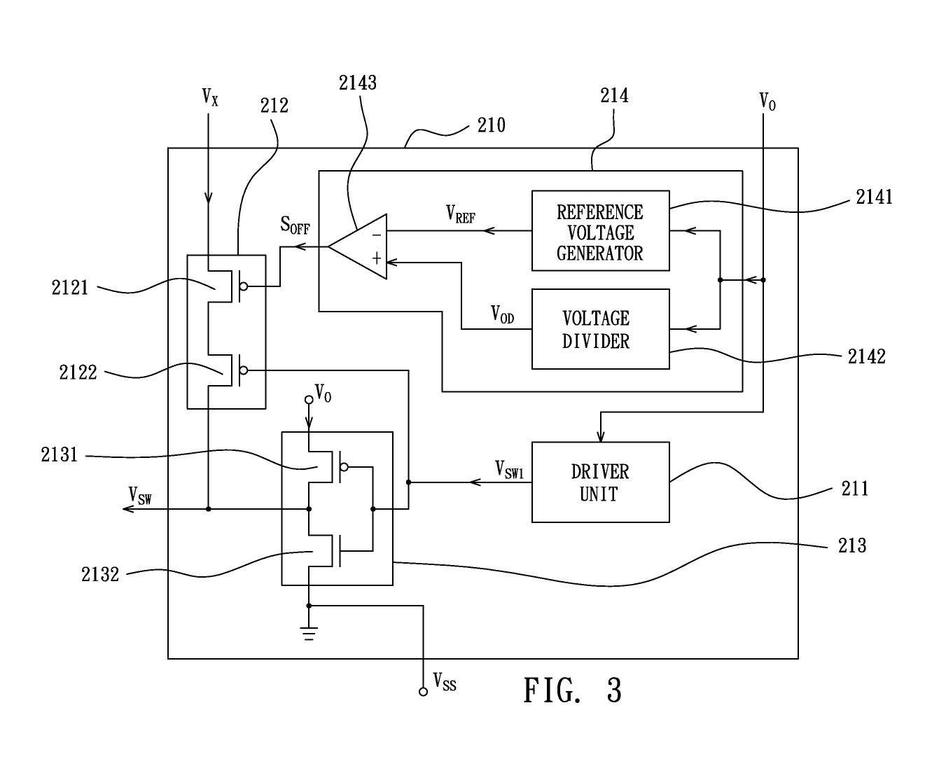

According to the principles mentioned above, the present invention proposes a preferred embodiment of the boost controller 210 as illustrated in FIG. 3, wherein the boost controller 210 has a first input end coupled to V_{X}, a second input end coupled to V_{O}, a switching signal output end for providing V_{SW}, and a common end for connecting to a ground V_{SS}; and the boost controller 210 includes a driver unit 211, a first inverter circuit 212, a second inverter circuit 213, and a comparator circuit 214.

The driver unit 211, powered by V_{O}, is used to generate a first switching signal V_{SW1}, of which the duty is determined by an error signal derived from the difference of V_{O} and a first reference voltage.

The first inverter circuit 212 includes a PMOS transistor 2121 and a PMOS transistor 2122, wherein the PMOS transistor 2121 has a source terminal coupled to V_{X}, a gate terminal coupled to a control signal S_{OFF}, and a drain terminal coupled to a source terminal of the PMOS transistor 2122; while the PMOS transistor 2122 has a gate terminal coupled to the first switching signal V_{SW1}, and a drain terminal coupled to the switching signal output end. When the control signal S_{OFF} is inactive (at a low level), the PMOS transistor 2121 will be turned on, and the PMOS transistor 2122 will act as an inverter. When the control signal S_{OFF} is active (at a high level), the PMOS transistor 2121 will be turned off, and the inverter function of the PMOS transistor 2122 will be disabled.

The second inverter circuit 213 includes a PMOS transistor 2131 and an NMOS transistor 2132, wherein the PMOS transistor 2131 has a source terminal coupled to V_{O}, a gate terminal coupled to the first switching signal V_{SW1}, and a drain terminal coupled to a drain terminal of the NMOS transistor 2132; while the NMOS transistor 2132 has the drain terminal coupled to the switching signal output end, a gate terminal coupled to the first switching signal V_{SW1}, and a source terminal coupled to the ground. When S_{OFF} is inactive (at a low level) and V_{SW1} is at a low level, V_{SW} will exhibit a high level, which is a superposition of V_{X} and V_{O}, higher than V_{O} but lower than V_{X}. When S_{OFF} is active (at a high level) and V_{SW1} is at a low level, V_{SW} will exhibit a high level, which is solely supplied by V_{O}.

The comparator circuit 214 includes a reference voltage generator 2141, a voltage divider 2142, and a comparator 2143, wherein the reference voltage generator 2141, powered by V_{O}, is used to generate a reference voltage V_{REF}; the voltage divider 2142 is used to generate V_{OD}—a divided voltage of V_{O}; and the comparator 2143 is used to generate the control signal S_{OFF} by comparing V_{OD} with V_{REF}, wherein S_{OFF} is at a low level when V_{OD} is lower than V_{REF}, and turns to be at a high level when V_{OD} is higher than V_{REF}.

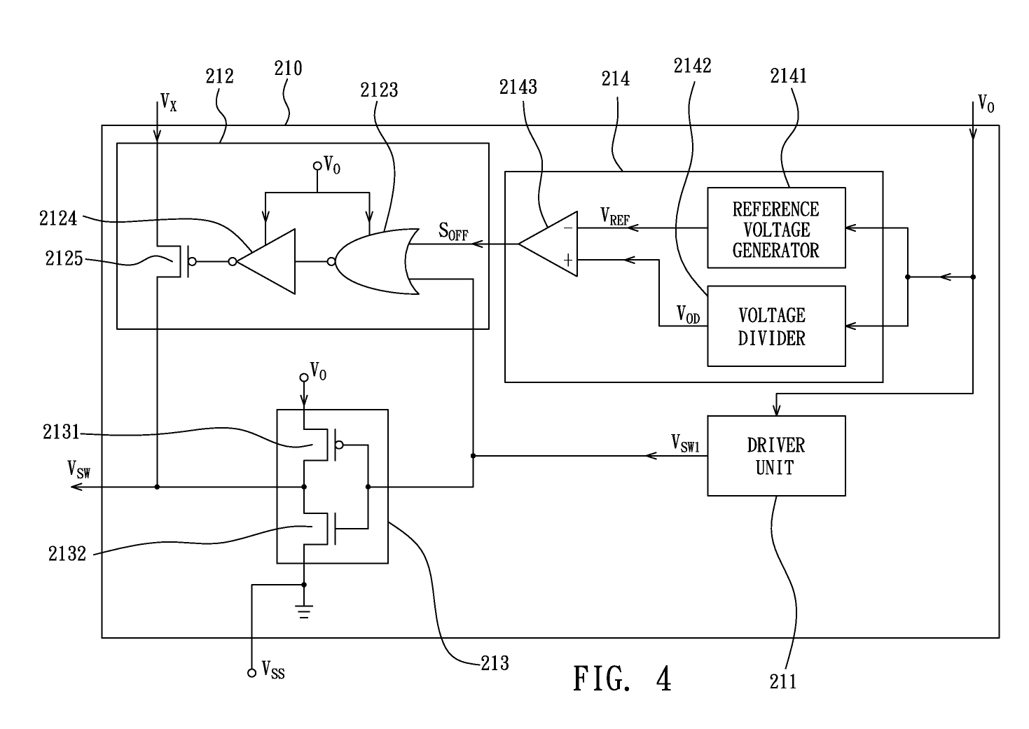

According to the principles mentioned above, the boost controller 210 of the present invention can have other embodiments. Please refer to FIG. 4, which illustrates the block diagram of a boost controller according to another preferred embodiment of the present invention. As illustrated in FIG. 4, the boost controller 210 has a first input end coupled to V_{X}, a second input end coupled to V_{O}, a switching signal output end for providing V_{SW}, and a common end for connecting to a ground V_{SS}; and the boost controller 210 includes a driver unit 211, a first inverter circuit 212, a second inverter circuit 213, and a comparator circuit 214.

As the operation principles of the driver unit 211, the second inverter circuit 213, and the comparator circuit 214 are elaborated above, they will not be readdressed here.

The first inverter circuit 212 includes a NOR gate 2123, an inverter 2124, and a PMOS transistor 2125, wherein the NOR gate 2123, powered by V_{O}, has a first input end coupled to S_{OFF}, a second input end coupled to V_{SW1}, and an output end coupled to the inverter 2124; the inverter 2124, powered by V_{O}, has an input end coupled to the output end of the NOR gate 2123, and an output end coupled to the PMOS transistor 2125; the PMOS transistor 2125 has a source terminal coupled to V_{X}, a gate terminal coupled to the output end of the inverter 2124, and a drain terminal coupled to the switching signal output end for enhancing the high level of V_{SW}.

When the control signal S_{OFF} is inactive (at a low level), the NOR gate 2123 will function as an inverter, and the combination of the NOR gate 2123, the inverter 2124, and the PMOS transistor 2125 will serve as an inverter. When the control signal S_{OFF} is active (at a high level), the output end of the NOR gate 2123 will exhibit a low level, the output end of the inverter 2124 will exhibit a high level, the PMOS transistor 2125 will be turned off, and the switching signal V_{SW} will be solely provided by the second inverter circuit 213.

As can be seen from the specification above, by using the boost controller of the present invention capable of enhancing the high level of the switching signal during a startup period, a boost converter circuit can operate at low environmental temperatures to boost a low input voltage to a higher output voltage, so the present invention does improve the prior art boost converters and boost controllers and is worthy of being granted a patent.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A low input voltage boost converter operable at low temperatures, comprising:
a boost controller, having a first input end coupled to the anode of a Shottky diode, a second input end coupled to an output voltage, a switching signal output end for providing a switching signal, and a common end for connecting to a ground, said boost controller comprising:
a driver unit, powered by the output voltage, being used to generate a first switching signal;
a first inverter circuit, powered by the voltage at the anode of said Shottky diode, having an input end coupled to said first switching signal, a control end coupled to a control signal, and an output end coupled to said switching signal output end, wherein said first inverter circuit is active when said control signal is inactive, and disabled when said control signal is active;
a second inverter circuit, powered by said output voltage, having an input end coupled to said first switching signal, and an output end coupled to said switching signal output end; and
a comparator circuit, used to generate said control signal by comparing said output voltage with a reference voltage; and
a first NMOS transistor, having a gate terminal coupled to said switching signal output end, a drain terminal coupled to the anode of said Shottky diode, and a source terminal coupled to said ground.

2. The low input voltage boost converter operable at low temperatures as claim 1, wherein said first inverter circuit comprises:
a first PMOS transistor, having a source terminal coupled to the anode of said Shottky diode, a gate terminal coupled to said control signal; and
a second PMOS transistor, having a source terminal coupled to a drain terminal of said first PMOS transistor; a gate terminal coupled to said first switching signal, and a drain terminal coupled to said switching signal output end.

3. The low input voltage boost converter operable at low temperatures as claim 1, wherein said first inverter circuit comprises:
a NOR gate, powered by said output voltage, having a first input end coupled to said control signal, a second input end coupled to said first switching signal, and an output end;
an inverter, powered by said output voltage, having an input end coupled to the output end of said NOR gate, and an output end; and
a PMOS transistor, having a source terminal coupled to the anode of said Shottky diode, a gate terminal coupled to the output end of said inverter, and a drain terminal coupled to said switching signal output end.

4. The low input voltage boost converter operable at low temperatures as claim 1, wherein said second inverter circuit comprises:
a third PMOS transistor, having a source terminal coupled to said output voltage, a gate terminal coupled to said first switching signal, and a drain terminal coupled to said switching signal output end; and
a second NMOS transistor, having a drain terminal coupled to said switching signal output end, a gate terminal coupled to said first switching signal, and a source terminal coupled to said ground.

5. The low input voltage boost converter operable at low temperatures as claim 1, wherein said comparator circuit comprises:
a reference voltage generator, powered by said output voltage, being used to generate a reference voltage;
a voltage divider, used to generate a divided voltage of said output voltage; and
a comparator, used to generate said control signal by comparing said divided voltage with said reference voltage.

6. A low input voltage boost controller operable at low temperatures, having a first input end coupled to the anode of a Shottky diode, a second input end coupled to an output voltage, a switching signal output end for providing a switching signal, and a common end for connecting to a ground, said boost controller comprising:
a driver unit, powered by the output voltage, being used to generate a first switching signal;
a first inverter circuit, powered by the voltage at the anode of said Shottky diode, having an input end coupled to said first switching signal, a control end coupled to a control signal, and an output end coupled to said switching signal output end, wherein said first inverter circuit is active when said control signal is inactive, and disabled when said control signal is active;
a second inverter circuit, powered by said output voltage, having an input end coupled to said first switching signal, and an output end coupled to said switching signal output end; and
a comparator circuit, used to generate said control signal by comparing said output voltage with a reference voltage.

7. The low input voltage boost controller operable at low temperatures as claim 6, wherein said first inverter circuit comprises:
a first PMOS transistor, having a source terminal coupled to the anode of said Shottky diode, a gate terminal coupled to said control signal; and
a second PMOS transistor, having a source terminal coupled to a drain terminal of said first PMOS transistor; a gate terminal coupled to said first switching signal, and a drain terminal coupled to said switching signal output end.

8. The low input voltage boost controller operable at low temperatures as claim 6, wherein said first inverter circuit comprises:
a NOR gate, powered by said output voltage, having a first input end coupled to said control signal, a second input end coupled to said first switching signal, and an output end;
an inverter, powered by said output voltage, having an input end coupled to the output end of said NOR gate, and an output end; and
a PMOS transistor, having a source terminal coupled to the anode of said Shottky diode, a gate terminal coupled to the output end of said inverter, and a drain terminal coupled to said switching signal output end.

9. The low input voltage boost controller operable at low temperatures as claim 6, wherein said second inverter circuit comprises:
a third PMOS transistor, having a source terminal coupled to said output voltage, a gate terminal coupled to said first switching signal, and a drain terminal coupled to said switching signal output end; and
a second NMOS transistor, having a drain terminal coupled to said switching signal output end, a gate terminal coupled to said first switching signal, and a source terminal coupled to said ground.

10. The low input voltage boost controller operable at low temperatures as claim 6, wherein said comparator circuit comprises:
a reference voltage generator, powered by said output voltage, being used to generate a reference voltage;
a voltage divider, used to generate a divided voltage of said output voltage; and
a comparator, used to generate said control signal by comparing said divided voltage with said reference voltage.
